(19) United States
(12) Patent Application Publication
(10) Pub. No.: US 2019/0224707 A1
(43) Pub. Date: Jul. 25, 2019

(54) Water spray gun with flow control

(71) Applicant: Ruey Ryh Enterprise Co., Ltd., Sioushuei Township Changhua County (TW)

(72) Inventor: Chen-Fu Hung, Sioushuei Township (TW)

(21) Appl. No.: 16/253,371

(22) Filed: Jan. 22, 2019

(30) Foreign Application Priority Data
Jan. 22, 2018 (TW) 107201019

(51) Int. Cl. B05B 12/00; F16K 5/04; F16K 5/18

(52) U.S. Cl. CPC B05B 12/002; F16K 5/188; F16K 5/04

(57) ABSTRACT

A water spray gun with flow control comprises a gun body having a water inlet, a water outlet and an accommodating chamber connected therebetween; a water control valve, being pivotably installed in the accommodating chamber and having a receiving recess being received in the accommodating chamber, wherein the receiving recess has its outside formed with an opening and has its bottom provided with a water-filling port; and a sealing block slidably installed in the receiving recess, so that when a pressure of water coming from the water-filling port acts on the sealing block from bottom, the sealing block slides toward the opening. Thereby, water pressure ensures close fit of the sealing block. Even if the sealing block is worn, the water pressure coming from the water-filling port can still push the sealing block outside to keep the water outlet sealed.

### TECHNICAL FIELD

The present invention relates to water spray guns, and more particularly to water spray gun having a novel flow control mechanism.

### BACKGROUND OF THE INVENTION

The known water guns, such as those disclosed in Taiwan Patents numbered 1344394, 1366434, 1559983 and M454712, are each a water spray gun having a water control valve pivotally installed in a chamber located between a water inlet and a water outlet, wherein water flow in controlled by contact between the water control valve and the water outlet. A large flow requires small a contact area between the water control valve and the water outlet, whereas sealing-up of the water outlet requires full coverage of the water control valve over the water outlet that prevents water coming from the water inlet from reaching the water outlet. For leakage-free sealing-up, a sealing sleeve configured to closely fit the surface of the water control valve is conventionally mounted around the water outlet.

However, such a known water spray gun tends to degrade after long-term use and have leakage. This is because the water control valve, as a moving part, can rub against the sealing sleeve after repeated operation, and once the sealing sleeve becomes worn, the tight-fitting level between the water control valve and the water outlet decreases. In this case, even if the water control valve is closed, the water outlet leaks, causing inconvenience to its users.

### BRIEF SUMMARY OF THE INVENTION

The present invention provides a water spray gun with flow control, which comprises a water gun body defining a water inlet and a water outlet, and having an accommodating chamber between the water inlet and the water outlet; a water control valve, being pivotably installed in the accommodating chamber, and having an operable portion exposed outside the gun body and a receiving recess being received in the accommodating chamber, wherein the receiving recess has its outside formed with an opening and has its bottom provided with a water-filling port; and a sealing block being slidably installed in the receiving recess, so that when a pressure of water coming from the water-filling port acts on the sealing block from bottom, the sealing block slides toward the opening.

In use of the disclosed water spray gun with flow control, when water is introduced into the accommodating chamber through the water inlet, a part of the water flows in to the water-filling port and pushes the sealing block to move toward the opening. For the water control valve to close the water outlet, the sealing block covers the water outlet, and the water pressure coming from the water-filling port ensures good sealing between the sealing block and the water outlet. Even if the sealing block is worn after long-term use, the water pressure coming from the water-filling port can still push the sealing block outward, thereby keeping the water outlet 12 sealed.

### BRIEF DESCRIPTION OF THE SEVERAL VIEWS OF THE DRAWINGS

FIG. 1 is an exploded view of a water spray gun according to one preferred embodiment of the present invention;

FIG. 2 is a cross-sectional view showing sealing-up of the water spray gun;

FIG. 3 is a cross-sectional view of a water spray gun according to another embodiment of the present invention;

FIG. 4 is a perspective view of an alternative sealing block of the water spray gun; and

FIG. 5 is an exploded view of an alternative water control valve of the water spray gun.

### DETAILED DESCRIPTION OF THE INVENTION

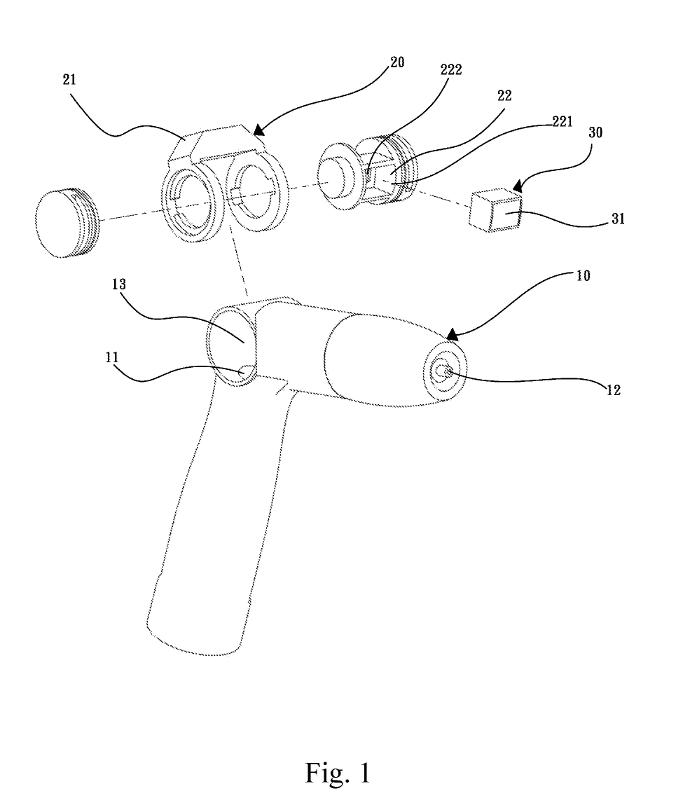

FIG. 1 is an exploded view of a water spray gun according to one preferred embodiment of the present invention. The water spray gun comprises the following components.

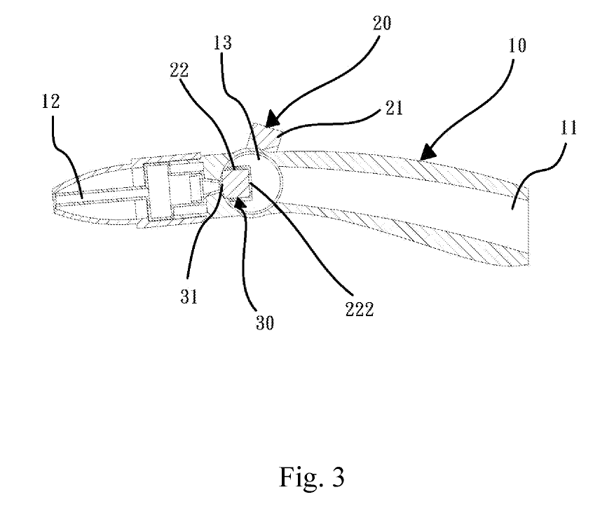

A gun body 10 defines a water inlet 11 and a water outlet 12. An accommodating chamber 13 is connected between the water inlet 11 and the water outlet 12. The water inlet 11 and the water outlet 12 are substantially perpendicular to each other. Alternatively, in another embodiment, as shown in FIG. 3, the water inlet 11 is substantially parallel to the water outlet 12.

A water control valve 20 is pivotally installed in the accommodating chamber 13. The water control valve 20 has an operable portion 21 exposed outside the gun body 10 and a receiving recess 22 received in the accommodating chamber 13. The receiving recess 22 has its outside formed with an opening 221 and has its bottom provided with a water-filling port 222.

A sealing block 30 is slidably installed in the receiving recess 22 and has its top provided with a convex portion 31.

For people skilled in the art to better understand the structural features, working principles and expected effects of the present invention, the following description is directed to operation of the disclosed water spray gun.

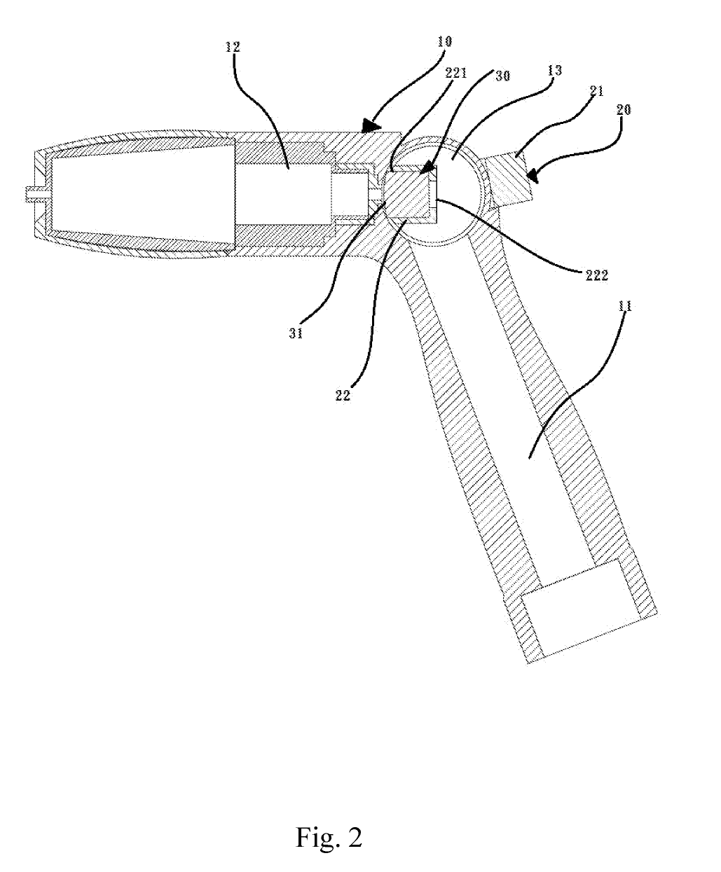

FIG. 2 is a cross-sectional view showing sealing-up of the water spray gun. As shown, water filled in at the water inlet 11 flows toward the water outlet 12 through the accommodating chamber 13. To prevent the water from going to the water outlet 12, a user can operate the operable portion 21 of the water control valve 20 by, for example, rotating it, so as to make the opening 221 of the receiving recess 22 face the water outlet 12 and make the sealing block 30 cover the water outlet 12. At this time, since a part of the water in the accommodating chamber 13 flows in the water-filling port 222, the sealing block 30 is such pushed toward the opening 221 by water pressure that the convex portion 31 at the top of the sealing block 30 firmly abuts against the wall of the receiving recess 22, thereby closing the water outlet 112. In this manner, water pressure ensures close fit of the sealing block 30. Even if the sealing block 30 is worn after long-term use, the water pressure coming from the water-filling port 222 can still push the sealing block 30 outward, thereby keeping the water outlet 12 sealed.

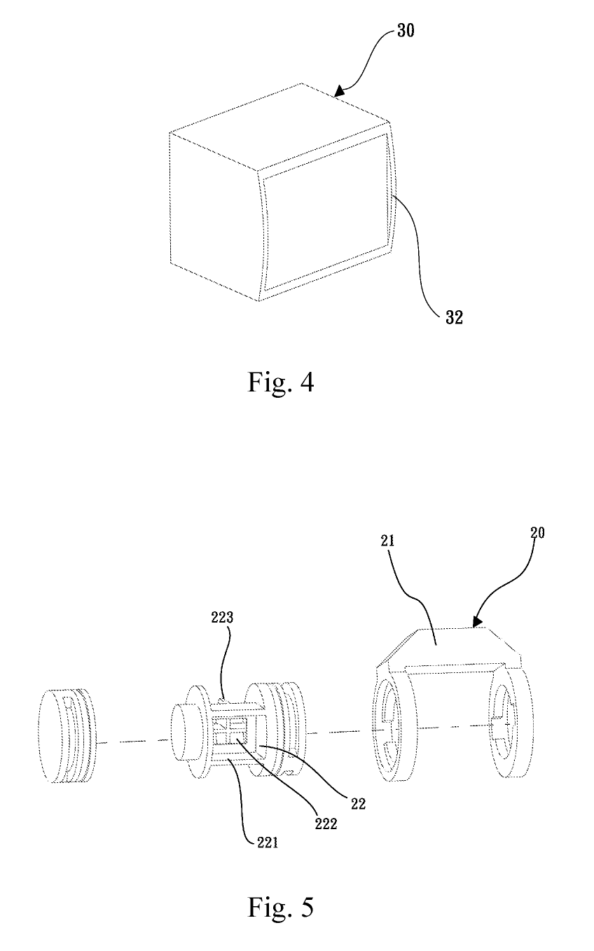

FIG. 4 is a perspective view of an alternative sealing block of the water spray gun. While the water spray gun and its counterpart in the previous embodiment are similar broadly, the sealing block 30 herein provides enhanced sealing effects by atop incorporating a raised rim 32. The raised rim 32 is configured to abut against the wall of the accommodating chamber 13, thereby preventing undesirably excessive friction. In addition, when the sealing block 30 is pushed by the water pressure from the water-filling port 222, the raised rim 32 deforms to improve close fit of the sealing block 30.

FIG. 5 is an exploded view of an alternative water control valve of the water spray gun. While the water spray gun and its counterpart in the previous embodiment are similar broadly, the receiving recess of the water control valve 20 has a cross-shaped scattering block 223 behind the water-filling port 222. The scattering block 223 serves to scatter water flowing into the water-filling port 222 for an evenly distributed water flow.

To sum up, the disclosed water spray gun is industrially practical and novel, and has not disclosed to the public, making it a novel and patentable invention.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

Labels:

10 gun body

11 inlet

12 outlet

13 accommodating chamber

20 water control valve

21 operable portion

22 receiving recess

221 opening

222 water-filling port

223 scattering block

30 sealing block

31 convex portion

32 raised rim

What is claimed is:

1. A water spray gun with flow control, comprising:
a gun body, defining a water inlet and a water outlet, and having an accommodating chamber connected between the water inlet and the water outlet;
a water control valve, being pivotably installed in the accommodating chamber, and having an operable portion exposed outside the gun body and a receiving recess being received in the accommodating chamber, wherein the receiving recess has its outside formed with an opening and has its bottom provided with a water-filling port; and
a sealing block being slidably installed in the receiving recess, so that when a pressure of water coming from the water-filling port acts on the sealing block from bottom, the sealing block slides toward the opening.

2. The water spray gun with flow control of claim 1, wherein the water inlet and the water outlet are substantially parallel to each other.

3. The water spray gun with flow control of claim 1, wherein the water inlet and the water outlet are substantially perpendicular to each other.

4. The water spray gun with flow control of claim 1, wherein the sealing block has its top provided with a convex portion.

5. The water spray gun with flow control of claim 1, wherein the sealing block is atop peripherally formed with a raised rim.

6. The water spray gun with flow control of claim 1, wherein the water control valve has a cross-shaped scattering block behind the water-filling port.
